(19) United States
(12) Patent Application Publication
(10) Pub. No.: US 2025/0250500 A1
(43) Pub. Date: Aug. 7, 2025

(54) LPG SYNTHESIS FROM BIO-BASED SOURCES

(71) Applicant: Lowell Street Ventures LLC, Washington, DC (US)

(72) Inventors: Steven Francis SCIAMANNA, Orinda, CA (US); Paul Frank Bryan, Pinole, CA (US); Dennis John O'rear, Petaluma, CA (US)

(73) Assignee: Lowell Street Ventures LLC, Washington, DC (US)

(21) Appl. No.: 18/431,438

(22) Filed: Feb. 2, 2024

(51) Int. Cl. C10L 3/12; B01D 3/14; B01D 53/047; B01D 53/14; B01D 53/26

(52) U.S. Cl. CPC C10L 3/12; B01D 3/143; B01D 53/047; B01D 53/1487; B01D 53/1493; B01D 53/26; B01D 2252/205; B01D 2256/24; B01D 2257/502; B01D 2257/504; B01D 2257/7022; B01D 2257/80; C10L 2200/0277; C10L 2200/0281; C10L 2200/0286; C10L 2290/541; C10L 2290/542

(57) ABSTRACT

A method is provided for synthesizing bio-based LPG from renewable sources via a bio-based synthetic gas feedstock, using a solvent absorption process and a solid adsorption process for recovering LPG in high yield while providing for high recovery and reuse, with low pressure drop, of unreacted synthesis gas components.

### FIELD OF THE DISCLOSURE

The invention is related to synthesis of liquefied petroleum gas (LPG) from bio-based sources.

### BACKGROUND

The issue of climate change is a real and growing problem. Carbon dioxide emissions from the burning of fossil fuels are the significant driving force. To address this issue various government regulations will soon require the use of renewable fuels as a component in conventional fuels, including propane and LPG. For example, the European renewable energy policy framework has just raised the EU target share of renewables to 40% by 2030.

The California Air Resources Board regulations require transportation fuel producers and importers to meet specified average carbon intensity requirements for fuel. Low Carbon Fuel Standard regulated fuels include natural gas, electricity, hydrogen, gasoline mixed with at least 10% corn-derived ethanol, biomass-based diesel, or propane.

Inland countries in Africa face a different issue. Propane and LPG are widely used as cooking fuels, but they must be imported and transported over land. This significantly increases their costs. Production of propane and LPG near the inland markets would be a cost savings, and, when produced from renewable resources, would also address climate change issues.

Thus, the demand for propane and LPG made from non-fossil and/or renewable resources (bio-based propane and bio-based LPG) is real, current, and worldwide.

There are several other issues regarding the synthesis/conversion reaction sequence using synthesis gas as a reactant. In one, significant amounts of hydrogen are present in the exit gas from the reactor. While recycling has been proposed, conventional recycling processes involve recompression of the recycled hydrogen, at significant energy costs. Secondly, in conventional processing, over 10% of the carbon introduced as reaction feedstock is produced as carbon dioxide. This represents a waste of the valuable carbon monoxide resource in the biosyngas. Accordingly, there continues to be a need for producing LPG from bio-based sources, using a sequence of processing steps that result in high LPG yields at low loss of the synthetic gas components, H2, CO, and CO2.

### SUMMARY

In one aspect, the present disclosure describes various embodiments of a system and a process for converting bio-based synthesis gas comprising CO and H₂ into LPG. One source of the bio-based synthesis gas is light hydrocarbon gases, principally methane, that have been generated from and recovered from one or more biomass sources.

In another aspect, the present disclosure provides an improved process for converting synthesis gas to higher than C3 hydrocarbons or C3+ hydrocarbons, principally LPG, that has multiple uses as a biofuel source of power and heat.

In another aspect, the present disclosure provides an improved process for converting greenhouse gases, principally methane, into bio-based fuels that may be used as automotive, commercial, and domestic sources of heat and power with reduced, and in some cases, minimal environmental impact.

In another aspect, the present disclosure provides a process for converting hydrocarbon gases generated from agricultural and municipal sources, including wastewater and sewage treating and solids disposal sites, into low environmental impact fuels.

In another aspect, the present disclosure provides an improved process for producing LPG from a synthesis process while recovering and efficiently recycling the unreacted synthesis gas components. The improved recycling process increases the recovery of valuable reaction byproducts and unreacted gaseous reactor feed components while reducing, and in some cases minimizing, the loss to the atmosphere of synthesis gas carbon that is tied up in product CO₂.

In another aspect, the present disclosure provides a process for recovering LPG at high efficiency from a gaseous reaction product mixture while recycling unreacted reaction product components at minimum pressure loss through the recovery process.

The present process is directed to the production of bio-based propane and, in the alternative, bio-based LPG, from bio-based synthesis gas. It is believed that the synthesis to LPG reaction goes through an oxygenate intermediate. In a 1^{st} reaction, an oxygenate is synthesized by reaction of synthesis gases over a suitable catalyst. Methanol (MeOH) and dimethyl ether (DME) are representative examples of the oxygenate. In a 2^{nd} reaction, the oxygenate is converted to hydrocarbons, principally LPG. Previous work on this reaction sequence has frequently integrated both catalyst functions into the same reactor either as mixtures or as a unified catalyst where both catalysts are mixed within single pellets or particles. The strategy for integrating both catalyst functions is that the oxygenate conversion catalyst will consume the oxygenates quickly thus promoting the rate of the oxygenate synthesis catalyst. Unfortunately, the reaction conditions (temperature and pressure) for the two reactions are not well matched. Oxygenate synthesis is favored at low temperatures and higher pressures relative to the oxygenate conversion catalyst.

During this reaction, carbon monoxide in the biosyngas can react with the byproduct water to form hydrogen and carbon dioxide via a water gas shift reaction and when metals are present, the reaction is often at equilibrium. The conversion of carbon monoxide in the biosyngas to carbon dioxide is undesirable since it competes with the conversion of carbon monoxide to desirable product bio-based propane.

Accordingly, the present invention is directed to a method for producing bio-based LPG, comprising (a) synthesizing an LPG-enriched gaseous effluent from a bio-based synthesis gas comprising CO, CO₂, and H₂ in one or more catalytic reaction zones; (b) removing an aqueous product from the LPG-enriched gaseous effluent and producing a dewatered gaseous effluent; (c) absorbing at least a portion of the hydrocarbons contained in the dewatered gaseous effluent in a liquid absorption solvent within an absorption zone and producing an LPG-enriched liquid comprising a bio-based LPG and a 1^{st} recycle stream having a reduced LPG content, wherein the 1^{st} recycle stream contains C2− hydrocarbons; (d) adsorbing C2− hydrocarbons, CO, and CO₂ onto a solid adsorbent from at least a portion of the 1^{st} recycle stream and returning non-adsorbed H₂ to the 1^{st} recycle stream to form a hydrogen-enriched 2^{nd} recycle stream; and (e) passing at least a portion of the 2^{nd} recycle stream to the one or more catalytic reaction zones.

A liquid absorption zone is provided for removing at least a portion of the LPG from reaction zone effluent while returning unreacted synthesis gas components in a recycle stream at minimal pressure drop. The liquid absorption process may process the entire dewatered gaseous effluent stream. Alternatively, a purge stream comprising between about 10% and about 90%, about 25% and about 75%, or about 30% and about 50% of the dewatered gaseous effluent is contacted with the liquid absorption solvent in the absorption zone for producing the LPG-enriched liquid. According to the invention, it has been found that contacting a purge stream with the liquid absorbent, rather than treating the entire effluent stream, benefits the process by reducing CO₂ loss without affecting the overall LPG recovery.

A solid adsorption zone is provided for removing light C2− hydrocarbons from the recycle stream prior to use of the recycle stream in LPG synthesis. The solid adsorption zone is selective for removing C2− hydrocarbons from the recycle stream, as well as a portion of the CO and CO₂ contained in the recycle stream. Most of the H₂ in the recycle stream is not removed in the solid adsorption step and is returned to the recycle stream to form a H₂-enriched stream prior to recycling the stream to the LPG synthesis reactions. Accordingly, the method includes adsorbing C2− hydrocarbons, CO, or CO₂ onto a solid adsorbent from at least a portion of the 1^{st} recycle stream and returning non-adsorbed H₂ to the 1^{st} recycle stream to form a hydrogen-enriched 2^{nd} recycle stream. In one aspect, the entire recycle stream may be treated in the solid adsorption zone. In another aspect, the method comprises contacting a 2^{nd} purge stream comprising between about 5% and about 50%, about 10% and about 40%, or about 15% and about 30% of the 1^{st} recycle stream and adsorbing C2− hydrocarbons, CO, and CO₂ onto the solid adsorbent from the 2^{nd} purge stream.

In another aspect, the present disclosure provides a method for producing bio-based LPG, comprising: (a) synthesizing an LPG-enriched gaseous effluent from a bio-based synthesis gas comprising CO, CO₂, and H₂ in one or more catalytic reaction zones; (b) removing an aqueous phase product from the LPG-enriched gaseous effluent and producing a dewatered gaseous effluent; (c) splitting the dewatered gaseous effluent into a 1^{st} recycle stream and a 1^{st} purge stream; (d) contacting the 1^{st} purge stream with a liquid absorption solvent in a hydrocarbon solvent absorption zone, absorbing at least a portion of hydrocarbons from the 1^{st} purge stream into the liquid absorption solvent and producing an LPG-enriched liquid and an LPG-depleted gaseous fraction comprising C2− hydrocarbons, H₂, CO and CO₂; (e) contacting at least a portion of the LPG-depleted gaseous fraction with a solid adsorbent in a solid adsorption zone for adsorbing at least a portion of the C2− hydrocarbons from the LPG-depleted gaseous fraction and producing a H₂-enriched gaseous fraction comprising non-adsorbed H₂ from the solid adsorption zone, and; (f) combining the H₂-enriched gaseous fraction and the 1^{st} recycle stream and passing at least a portion of the combined stream to the one or more catalytic reaction zones.

A mostly used practical method to remove water is by simple cooling and condensation. Absorption might be considered to remove traces of water, as an alternative. The sponge oil system is one of the mostly used way to remove the C3+ product. As an alternative, solid adsorption, such as silica gel, is used to remove the C3+ product. Distillation is another alternative, but requires expensive cryogenic separation. Removal of the C2− hydrocarbons is best done by a solid adsorbent (PSA). A less attractive variation on this process is a TSA, temperature swing adsorption.

The method optionally further comprises (g) splitting the LPG-depleted gaseous stream into a 2^{nd} purge stream and a 2^{nd} recycle stream; (h) contacting the 2^{nd} purge stream with the solid adsorbent in the solid adsorption zone for adsorbing at least a portion of the C2− hydrocarbons from the 2^{nd} purge stream producing a H₂-enriched gaseous fraction comprising the non-adsorbed H₂ from the solid adsorption zone; and (i) combining the H₂-enriched gaseous fraction, the 2^{nd} recycle stream and the 1^{st} recycle stream and passing at least a portion of the combined stream to the one or more catalytic reaction zones.

In effect, the disclosed embodiments of the present invention enable preparation of LPG from bio-based sources at high LPG yield and low loss of synthetic gas components H₂, CO, and CO₂ in the recycle process.

### BRIEF DESCRIPTION OF THE DRAWINGS

FIG. 1 illustrates an embodiment of present invention describing a method for producing bio-based LPG.

FIG. 2 illustrates another embodiment of present invention describing a method for producing bio-based LPG.

FIG. 3 illustrates a schematic drawing of a system and a process for synthesizing a bio-based LPG from syngas that is derived from a bio-based source.

FIG. 4 further illustrates an embodiment of the present invention for recovering LPG and other reaction products and by-products from the gaseous reaction effluent.

### DETAILED DESCRIPTION

As used here, “C2− hydrocarbons” refers to methane and ethane, either alone or in combination. Likewise, “C2+ hydrocarbons” refers to hydrocarbons composed of 2 or more carbons (e.g., ethane, propane, etc.) Likewise, “C5+ hydrocarbons” refers to hydrocarbons composed of five or more carbon (pentane, hexane, etc.).

As used herein, the term “LPG” refers to liquefied petroleum gas and a composition comprising mixture of hydrocarbon gases, such as propane, propylene, butylene, isobutane, or n-butane. However, the term may refer to slightly different compositions, depending on the market to which the LPG is directed. For example, European LPG is a mixture of light hydrocarbons comprising propane and optionally n-butane and iso-butane. It is synonymous with AutoGas. Smaller amount of ethane and C5+ may be present. In the United States, LPG mostly refers to propane. BioLPG is LPG made from biogas.

As used herein, the terms “LPG and “bioLPG” are used interchangeably unless otherwise specified. According to the present disclosure, the composition of any LPG produced as described herein may be tailored by distillate fractionation and the present process is suitable for producing LPG across a range of compositions. Thus, the term “LPG” as used herein refers to a mixture of propane and butane (n-butane and/or i-butane) in any composition ratio.

As used herein, “H₂”, “CO”, “CO₂”, “MeOH”, and “DME” have conventional designations, referring to molecular hydrogen, carbon monoxide, carbon dioxide, methanol and dimethyl ether.

As used herein, a “bio-based” material refers to a material that is sourced from one or more natural resources, which will replenish to replace the portion depleted by usage and consumption, either through natural reproduction or other recurring processes in a finite amount of time in a human time scale.

As used herein, “biogas” refers to a gaseous material comprising methane containing carbon and/or hydrogen that is derived from bio-based resources. A biogas recovered from biomass processing may also comprise CO₂. In one aspect, biogas comprises methane and CO₂ in a molar ratio ranging from 80:20 to 20:80, 70:30 to 30:70, 60:40 to 40:60, or 50:50.

As used herein, “syngas” or, in the alternative, “synthesis gas” refers to a mixture of H₂ and CO, in various ratios. Syngas often contains one or more of CO₂, CH₄, and H₂O, at lower concentrations.

As used herein, “biosyngas” refers to a syngas comprising CO and H₂, some or all of which are derived from bio-based sources.

As used herein, “oxygenate” refers to hydrocarbons containing oxygen. Examples include alcohols, such as methanol (MeOH) and dimethyl ether (DME). Biooxygenate, biomethanol or biodimethyl ether are materials derived from biosyngas.

As used herein, bio-based CO refers to CO containing carbon that is sourced from renewable sources, from biological sources, or from carbon capture process involving capture of CO and CO₂ from the atmosphere, from flue gas and the like.

As used herein, the terms “reaction zone temperature” and “catalyst temperature” refer to the average catalyst bed temperature during the catalytic reaction process. In one aspect, the catalyst temperature is a numerical average of the temperature of the operating catalyst bed at the feed inlet and the temperature of the operating catalyst bed at the product outlet.

As used herein, the term “molecular sieve” is a crystalline substance with pores of molecular dimensions which permit the passage of molecules below a certain size. It is commonly used as a commercial adsorbent and catalyst. Exemplary molecular sieves include phosphate molecular sieves (comprising silicon, aluminum, phosphorous, oxygen) or zeolites (comprising silicon, aluminum, and oxygen). Non-limiting examples of phosphate molecular sieves include SAPO-18 or SAPO-34. Non-limiting examples of zeolitic molecular sieves include Beta zeolite, Y-zeolite, SSZ-13, or ZSM-5. In the context of a catalyst particle, “non-zeolitic” refers to a catalyst containing no zeolites or phosphate molecular sieves. In the context of a catalyst bed, “non-zeolitic” refers to a bed of catalyst particles containing no zeolites or phosphate molecular sieves.

The gaseous feed to the reforming reaction zone comprises methane, in some cases with decreasing amounts of C2+ higher hydrocarbons, recovered from a source of biogas. Biogas that is generated for use according to the present disclosure contains biomethane or methane which is derived in part or in whole from a bio-based resource. Exemplary sources of bio-based methane include (i) methane obtained from anaerobic bacterial digestion of agricultural waste, municipal biowastes or from wastewater treatment, (ii) gaseous products of biomass conversion (e.g., composting, biomass gasification, pyrolysis, or hydropyrolysis, such as in the case of supercritical water gasification of biomass), (iii) landfill gases, or (iv) gaseous products of the electrochemical reduction of carbon dioxide. Carbon from bio-based carbon sources is termed “bio-based carbon”.

In some aspects, hydrogen may be added in the process to, for example, adjust the H₂/(CO+CO₂) content of a synthesis gas feed. Sources of LPG hydrogen may include the biogas source of biosynthetic gas. Additional sources include water and hydrogen that may be added to the process, and hydrogen recycle within the process. To maintain the bio-based aspect of the LPG, it is desirable to source the hydrogen from bio-based or renewable sources, or from sources that involve no net CO₂ evolution. Suitable sources include hydrogen produced by using clean energy from surplus renewable energy sources, such as for example, but not limited to solar or wind power, to split water into two hydrogen atoms and one oxygen atom through a process called electrolysis, and gasification of biomass and subsequent steam reforming of the bio-syngas. Another suitable source includes hydrogen that is produced from steam reforming and the byproduct carbon compounds are captured and stored underground through an industrial carbon capture and storage (CSS) process. Other suitable hydrogen may be sourced from renewable sources, from biological sources, from electrolysis of water using solar, wind, wave, or other renewable energy sources or from naturally occurring geological hydrogen (commonly referred to as natural, gold or white hydrogen) or from nuclear powered electrolysis of water (commonly referred to as pink hydrogen).

Biogas may also contain CO₂, CO, ethane, water vapor, and nitrogen, depending on the specific process from which the biogas is generated. Raw (untreated) biogas may be passed to a reforming process without further treatment. Alternatively, some of the non-methane components may be removed, either in part or in whole, and the treated biogas passed to the reformer for conversion into biosyngas. Water that is present in the raw biogas may be condensed and removed from the biogas, using, for example, a water knockout pot for the two-phase separation. Non-hydrocarbon compounds (such as sulfur-, or nitrogen-, or acid-containing compounds) that are present in the raw biogas are removed to low levels, and often to ppm levels, using, for example, one or more of aqueous washing, alkanolamine absorption, molecular sieve adsorption, selective catalytic oxidation, and hydrodesulfurization.

Carbon dioxide may be removed from the raw biogas in combination with sulfur removal. Additional CO₂ may be removed by membrane separation, by cryogenic distillation or by aqueous absorption, which includes contacting the biogas with water or caustic solutions to dissolve CO₂, separating the water/CO₂ mixture, removing the CO₂ from the mixture by increasing the temperature and/or decreasing the pressure of the mixture, and recycling the water. CO₂ may also be removed in part by aqueous absorption into the water that is condensed and removed from the biogas. In some embodiments, at least a portion of one or more of CO₂, CO and water vapor may be retained in the treated biogas feed to maintain the desired H₂/(CO+CO₂) ratio of the biosyngas exiting the reformer.

Carbon dioxide and/or water may also be added to the biogas feed from an external source to the reformer to control the H₂/(CO+CO₂) ratio in the biosyngas produced in the reformer. In embodiments, carbon in the added carbon dioxide is from a bio-based resource, with the addition of carbon from a bio-based resource controlled to maintain a biogas carbon content of, for example, at least about 70 weight % that is bio-based carbon not derived from petroleum.

Recycle gas comprising H₂, CO, CO₂ and optionally methane and traces of C2+ hydrocarbons may also be added to the biogas, prior to passing the biogas as feed to the reforming reaction zone.

Biosyngas comprising H₂ and CO may be produced by contacting a biogas comprising biomethane with an oxidizing gas selected from O₂, CO₂ and H₂O or combinations thereof at reforming reaction conditions in a reforming reaction zone to produce a biosyngas comprising H₂ and CO.

Biosyngas may be produced by biomass gasification, involving contacting biomass with some combination of air, oxygen, and/or steam at elevated temperatures. Fluidized-bed, fixed-bed or indirect heated gasifiers may be used. Varying steam to oxygen ratio input is a way to adjust the H₂/(CO+CO₂) ratio to match synthesis gas requirements. Gasifier temperatures may be between about 1,000° C. and about 1,300° C. or higher in some operations.

In another aspect, syngas (or alternatively biosyngas) may be produced in a methane reformer involving steam reforming, autothermal reforming or partial oxidation to convert methane to hydrogen and carbon oxide gases. Either a fired biogas reformer or an electrical biogas reformer may be used. Reforming conditions include pressures between about 200 psi and about 600 psi (14-40 bar) and outlet temperatures between about 815° C. and about 925° C. Because the catalyst is sensitive to sulfur, the sulfur content of the biogas must be reduced to less than 10 ppm, preferably less than 1 ppm.

In steam methane reforming, steam reacts with methane as follows:

CH₄+H₂O→CO+3H₂

In the absence of steam, dry reforming proceeds as follows:

CH₄+CO₂→2CO+2H₂

The reactants in the reforming reaction zone may also be converted by a water gas shift (WGS) reaction over the metal reforming catalysts (e.g., shaped nickel alumina catalysts):

CO+H₂O⇄CO₂+H₂

Therefore, adjusting the amount of CO₂ and H₂O added to the methane reforming reaction zone feed is useful for controlling the H₂/(CO+CO₂) ratio of the syngas generated during reforming. The composition of syngas generated in the reforming reaction zone, and in particular the H₂/(CO+CO₂) ratio in the syngas, may be controlled for efficient downstream conversion of the syngas to LPG. If the H₂/(CO+CO₂) ratio is too low, CO conversion is reduced and if the H₂/(CO+CO₂) ratio is too high, large quantities of H₂ must be recycled. Synthesis of oxygenates in the synthesis reaction zone generally proceeds with a H₂/(CO+CO₂) molar ratio in the synthesis reaction zone feed in a range between 1 and 4 (e.g., in a range between 2 and 3). When the feed contains less than or equal to 1 mol % CO₂, the H₂/(CO+CO₂) ratio may be in a range between 2.25 and 2.45. When the feed contains more than 1 mol % CO₂ the H₂/(CO+CO₂) ratio may be in the range of 2.2 to 2.5.

For managing control of environmental emissions from the process, additional CO₂ may be added to the gaseous feed to the reforming reaction zone. In embodiments, the CO₂ used in the reformer is recovered either from the biogas generation reactor, from the recycle of unreacted products from the process, or from both. In particular, biogas generated from biomass includes CO₂ that may be removed from the biogas as a pure CO₂ product, making it highly suitable for blending into the blended synthesis gas feed to the synthesis reaction zone. Thus, in some cases, the synthesis gas feed may further comprise CO₂, for example in an amount of at least about 5-50 mol % (e.g., about 4-50 mole %, about 5-20%, about 7-25 mole % or about 8-10 mole %). One embodiment, the synthesis gas feed comprises about 8-10 mol % CO₂. The rate of methanol formation may be enhanced the most when the feed contains 5-20% CO₂.

Controlling for the amount of water supplied to the synthesis reaction zone may also influence the synthesis reactions in the synthesis reaction zone. In particular, the addition of steam to the reaction zone, and the reaction of the steam with CO by WGS that is generated in a reforming reaction step in the synthesis reaction zone increases the H₂/(CO+CO₂) in the reaction zone. Likewise, increasing the CO₂ introduced to the synthesis reaction zone decreases the H₂/(CO+CO₂) by RWGS (reverse WGS).

Methane reforming for generating synthesis gas is generally conducted with a methane rich feed, comprising little or no C2+ components. Processes using a biogas feedstock containing excess C2+ hydrocarbons may include a pre-reformer for converting the C2+ hydrocarbons to methane. In embodiments, a primary source of C2+ components in the biogas feedstock is the recycle from the LPG fractionator and/or the hydrogen from the PSA module, and a suitable pre-reformer may be included to process one or both of these streams. Suitable pre-reforming systems are known and are readily available.

The biosyngas that is supplied to an LPG synthesis reaction zone includes the biosyngas produced in the reforming reaction zone. Other suitable sources of biosyngas include one or more recycle streams generated in the process. Additional CO and/or H₂, some or all of which may be bio-based CO and/or bio-based H₂ may be supplied from external sources.

The process, according to the present invention, is directed at least in part to producing an LPG-enriched gaseous effluent by a catalytic synthesis process. In embodiments, the process comprises reacting a blended biosyngas comprising fresh biosyngas and at least a portion of a recycle stream over an LPG synthesis catalyst in at least one synthesis reaction zone at an LPG synthesis reaction temperature and producing an LPG-enriched gaseous effluent.

The synthesis catalyst comprises at least one oxygenate synthesis catalyst for converting the biosyngas into oxygenates such as methanol, and a oxygenate conversion catalyst for converting the oxygenates into hydrocarbons, including LPG.

In embodiments, bioLPG is synthesized from biosyngas in a single-stage synthesis process, comprising reacting the biosyngas over an LPG synthesis catalyst comprising an oxygenate synthesis catalyst, and an oxygenate conversion catalyst in a single-stage LPG synthesis reaction zone maintained at an LPG synthesis reaction temperature, and producing an LPG-enriched gaseous effluent.

The oxygenate synthesis catalyst comprises one or more oxygenate synthesis-active metals selected from the group consisting of Cu, Zn, Zr, Al, Pt, Pd, and Cr. CuZnAlOx and ZnCrAlOx are two suitable examples of an oxygenate synthesis catalyst. As disclosed herein, the oxygenate synthesis catalyst is a non-zeolitic catalyst, containing little (i.e., less than 2 wt %) or molecular sieve component.

The oxygenate conversion catalyst, comprising a molecular sieve, for example SSZ-13, SAPO-18, SAPO-34, beta zeolite, ZSM-5 or Y-zeolite, converts the oxygenate formed in the synthesis step to a hydrocarbon, i.e., converts DME and MeOH to light hydrocarbons, including LPG. In an embodiment, the oxygenate conversion catalyst converts all the oxygenates such that they are at low or undetectable levels in the effluent. This simplifies recovery of the desired LPG product.

Reaction conditions for the single-stage synthesis process includes an average catalyst bed temperature between about 200° C. and about 450° C. or between about 220° C. and about 350° C. or between about 240° C. and about 325° C., and a pressure between about 250 psi and about 1500 psi, or between about 400 psi and about 1200 psi or between about 700 psi and about 1000 psi. The biosyngas feedstock is generally heated to a temperature between about 200° C. and about 450° C. prior to being introduced to the single-stage reaction zone. As used herein, average catalyst bed temperature is the numerical average of the catalyst bed temperature at the feed inlet to the catalyst bed and the catalyst bed temperature at the product effluent exit from the catalyst bed.

The pressures of the synthesis reaction zone and hydrocarbon conversion zone should be the same with small allowances for pressure drop between reactors (less than 50 psi). Examples of pressure ranges for both are 250-1500 psi, 725-1000 psi, or 750-950 psi. If pressures of the synthesis reaction zone and hydrocarbon conversion zone are too low, syngas conversion will be low as will the overall rate of reaction. If pressures are too high, the capital for the process increases.

Example ranges for the temperature of the synthesis reaction zone are 200-400° C., 220-350° C., 240-280° C., or 250-270° C. If temperatures of the synthesis reaction zone are too low, the rate of reaction is too slow. If temperatures are too high the catalyst fouls quickly and methane by-product yields increase.

Examples ranges for the temperatures of the hydrocarbon reaction zone are 280-500° C., 300-475° C., or 310-425° C. If temperatures of the hydrocarbon reaction zone are too low, oxygenates will be present in the effluent and this will complicate product recovery. If temperatures are too high, the catalyst will foul and methane by-product yields will increase.

In the single stage process, the catalysts for converting biosynthesis gas to LPG are in a single reaction vessel containing the catalysts. The catalyst components may be composited as a single particle containing the three components. Alternatively, one or more of the components may be present in the reaction zone as separate particles, either mixed with the other component particles to make a uniform catalyst bed, or the one or more of the components may be layered in the reaction zone as a separate catalyst layer.

In embodiments, the bioLPG may be synthesized from biosyngas in a dual-stage synthesis process, comprising reacting the biosyngas over an oxygenate synthesis catalyst and reacting the gaseous effluent from the oxygenate synthesis reaction zone over an oxygenate conversion catalyst in an oxygenate conversion reaction zone at oxygenate conversion reaction conditions, and producing an LPG-enriched gaseous effluent. The two-stage catalyst system may be a part of a multi-stage catalyst system, in which the two stages of the system are separate, or, if in a single reaction vessel, spaced apart by a spacer element, such as a heat exchange element.

Oxygenate-containing effluent from the oxygenate synthesis reaction zone may be heated by heat exchange, and the heated effluent passed to the oxygenate conversion reaction zone for conversion to hydrocarbons, including LPG.

In an embodiment, the oxygenate synthesis reaction zone may be configured and operated to produce an effluent stream rich in MeOH. The oxygenate synthesis reaction proceeds by contacting a syngas (e.g., a biosyngas) with a non-zeolitic oxygenate synthesis catalyst at synthesis reaction conditions. Synthesis reaction conditions include a first reaction zone temperatures of between about 200° C. and about 400° C., between about 220° C. and about 350° C., or between about 240° C. and about 280° C. The inlet pressure is between about 250 psi and about 1500 psi, or between about 400 psi and about 800 psi, or between about 600 psi and about 750 psi. The oxygenate synthesis catalyst comprises one or more oxygenate synthesis-active metals selected from the group consisting of Cu, Zn, Zr, Al, Pt, Pd, and Cr. CuZnALOx (with a Cu/Zn/Al molar ratio of around 6:3:1) and ZnCrAlOx (with a Zn/Cr/Al molar ratio of around 1:1:2) are two suitable examples of an oxygenate synthesis catalyst. To facilitate MeOH production in the oxygenate synthesis reaction zone, the reaction zone contains less than 5 wt % of a molecular sieve or zeolitic catalyst. In embodiments, the synthesis reaction zone contains essentially no molecular sieve or zeolite catalyst.

With use of oxygenate synthesis catalyst having little or no molecular sieve component, less than 25%, or less than 10%, or less than 5%, or even less than 1% of the MeOH-enriched effluent from the synthesis reaction zone is a dehydrated oxygenate such as DME. In embodiments, the synthesis reaction zone contains essentially no molecular sieve or zeolite component. In one aspect, “essentially no molecular sieve or zeolite component” is understood to mean that there is insufficient molecular sieve or zeolite component in the catalyst to have a measurable effect on the performance of the catalyst, and more particularly on the formation of dehydrated oxygenates, such as DME. In one aspect, with the combination of catalysts as described herein for producing LPG, the overall CO conversion is between about 25% and about 45%.

Bio-based MeOH is an important commodity for use in a variety of applications.

Accordingly, a fraction of the MeOH that is generated in the oxygenate synthesis reaction zone, and in some cases a large fraction, may be removed from the process, and only a fraction of the synthesized MeOH passed to the 2^{nd} conversion reaction zone for conversion to LPG.

Gaseous effluent comprising DME and/or MeOH from the synthesis reaction zone is passed, in whole or in part, to the conversion reaction zone. When available, additional DME or MeOH from an external source may be added to the oxygenate conversion reaction zone feed, including additional bio-based DME and/or bio-based MeOH. Likewise, ethanol, ethylene and propylene from microbial fermentation of a biomass substrate may further contribute to the production of bio-based LPG.

Alternatively, some of the oxygenates present in the synthesis effluent stream may be removed from the effluent stream and purified for other uses before the remainder of the synthesis effluent stream is passed to the conversion reaction zone.

Prior to flowing the synthesis gaseous effluent stream to the conversion reaction zone, the effluent stream may be preheated to match the conversion reaction zone operating temperature, including, for example, by heating the synthesis gaseous effluent stream to a temperature between about 280° C. and about 500° C., or between about 300° C. and about 475° C. before being passed to the conversion reaction zone.

While the gaseous reacting stream flowing to the conversion reaction zone comprises DME and/or MeOH in varying amounts, the stream also includes the unreacted syngas components H₂, CO and CO₂, hydrocarbons, and byproduct water. A portion of the hydrocarbons in the reacting stream is supplied in the recycle stream. Most of the components in the synthesis reaction zone effluent, except for H₂, DME and MeOH, are inert under oxygenate conversion reaction conditions. Any water, hydrocarbons, CO and CO₂ present in the effluent stream will pass through the conversion reaction zone, undergoing few, if any, reactions that alter the nature of the inert materials. The entire effluent stream from the synthesis reaction zone may therefore be passed to the conversion reaction zone for converting oxygenates in the effluent stream to hydrocarbons, including LPG.

In some applications of the process of the disclosure, a portion of the inert materials included in the effluent are removed before the remaining effluent is passed to the conversion reaction zone. For example, the presence of one or more of the inert components, when passed to the synthesis reaction zone, may change the concentration of reactions, and thereby reduce the reaction rate of the synthesis reaction.

In embodiments, the process includes converting the oxygenates formed in the oxygenate synthesis reaction zone into paraffinic hydrocarbons, including C3 and C4 paraffinic hydrocarbons. The conversion reactions include dehydration of the oxygenates and saturation of olefins formed during dehydration, while limiting water gas shift reactions that convert available carbon in the reacting mix into CO₂.

In one aspect, the oxygenate conversion catalyst comprises a molecular sieve or zeolite. Non-limiting molecular sieves that are suitable for oxygenate conversion in a conversion reaction zone to produce an LPG-enriched gaseous effluent include SSZ-13, SAPO-18, SAPO-34, beta zeolite, ZSM-5 and Y-zeolite.

In another aspect, the molecular sieve or zeolite component of the conversion reaction zone catalyst is characterized by a SiO₂:Al₂O₃ ratio in a range between 10-90. The conversion catalyst may be compounded in a particulate alumina matrix and employed as spheres or extrudates in the reaction zone, the particulates having a cross-sectional diameter between 1/32 inch to ¼ inch. The extrudates may be shaped into tri-lobed form or similar to provide better access to the internal portion of the extrudate while maintaining mechanical strength.

In another aspect, the oxygenate conversion catalyst contains few, if any, metal species that are active for catalyzing water gas shift reactions. Metals that contribute to water gas shift activity of the conversion catalyst includes Fe, Cu, Zn, Pt, and Pd. The oxygenate conversion catalyst in the present process contains less than 5 wt % of these metals, or less than 1 wt % of these metals, either alone or in combination. In embodiments, the oxygenate conversion catalyst contains essentially no water gas shift active metal component. In one aspect, “essentially no water gas shift active metal component” is understood to mean that there is insufficient metal component in the catalyst to have a measurable effect on the performance of the catalyst, and more particularly on the WGS activity of the catalyst.

The oxygenate conversion reaction is generally conducted at a temperature between about 280° C. and about 500° C., or between about 300° C. and about 475° C. In another aspect, the temperature of the gaseous feed to the oxygenate conversion zone is at least 50° C. greater than the temperature of the gaseous feed to the oxygenate synthesis zone. The pressure may be the same for both reaction zones with allowance for some pressure drop between about the reactors. Thus, the oxygenate conversion reaction zone may operate at a pressure between about 250 psi and about 1500 psi, or between about 400 psi and about 800 psi, or even between about 600 psi and about 750 psi.

The conversion reactor gaseous effluent comprises H₂O, H₂, CO, CO₂, LPG, inerts (such as N₂) and C2− and C5+ hydrocarbons. Separation and recovery of LPG at high purity involves a separation sequence involving one or more separation steps. A liquid absorption solvent in, for example, a sponge oil absorption process may be employed for recovering most, if not all of the LPG contained in the effluent. A solid absorbent in, for example, a Pressure Swing Adsorption (i.e., PSA) process may be employed for removing C2− hydrocarbons from a recycle stream produced in the liquid absorption process.

An example of a liquid absorption process includes, but not limited to, sponge oil absorption process. Sponge Oil Absorption is a well-established commercial process that removes relatively heavier gaseous hydrocarbons from lighter gaseous hydrocarbons in a gas mixture by contacting a gas mixture with a hydrocarbon liquid (lean liquid) at elevated pressure and relatively lower temperature in an absorption zone. The heavier gaseous hydrocarbons preferentially absorb in the hydrocarbon liquid. The liquid hydrocarbon with the dissolved heavier gaseous hydrocarbons is referred to as a rich liquid. The rich liquid is then processed in a desorption zone at temperatures above those in the absorption zone and pressures below those in the absorption zone. This desorbs the adsorbed heavier gaseous hydrocarbons from the rich liquid and forms the lean liquid which is recycled to the absorption zone. The key properties of the hydrocarbon liquid are that it should be fluid at the conditions of the absorption zone and no significant portion should volatilize at the conditions of the desorption zone. A variety of hydrocarbon liquids can be used including kerosene, diesel, jet fuel, heavy naphtha, n-hexadecane and light cycle oil. Non limiting examples are U.S. Pat. Nos. 2,930,752A, 3,477,946A, or 7,107,788B2, the contents of each of which are incorporated herein by reference.

Pressure Swing Adsorption is a commercial process used to separate hydrogen and hydrocarbon gases. In context of this application, the adsorption unit should preferably adsorb hydrocarbons (methane, ethane, propane, butane, C5+) and not adsorb significant amounts of hydrogen. In this way the hydrocarbons are removed from the recycle gas stream and the pressure of the hydrogen-enriched recycle gas stream is not significantly reduced. Maintaining the pressure of the hydrogen-enriched recycle gas minimizes recompression cost to get this steam back to the inlet of the biooxygenate synthesis process. The adsorbed hydrocarbons are desorbed and sent to a deethanizer. The C3+ hydrocarbons are recovered as a product, and the methane and ethane are used as fuel or feed to a biogas reformer. The adsorber will use a molecular sieve, commonly 5 A molecular sieve, or a carbon molecular sieve. The adsorption unit will optionally include a dehydrator ahead of the adsorption unit. There are two kinds of dehydrators: glycol dehydrators link and molecular sieve dehydrators.

Deethanizer, depropanizer, debutanizer are used in gas processing plants to separate individual hydrocarbons. These are continuously run distillation columns where the mentioned hydrocarbon is removed as an overhead stream. The overhead stream in each of these processes will need to be partially condensed to provide a reflux to the column. To do this condensation it is preferred to operate the columns at sufficient pressure such that the condensation can be done by use of cooling water rather than a refrigerated liquid.

In embodiments, the process comprises removing liquid water from the LPG-enriched gaseous effluent and recovering a dewatered gaseous effluent. The gaseous reactor effluent normally contains between 10 mol %-30 mol % water vapor that may be removed, at least in part, by cooling the effluent below the water condensation temperature but without condensing the hydrocarbons in the effluent. Thus, one of the separation steps may involve cooling the effluent stream sufficiently to condense a liquid aqueous phase and removing the aqueous phase from a dewatered gaseous phase effluent in a two-phase separator (commonly termed a “water knockout pot”) for disposal, for recycling to the present process, or for other uses. A portion of the CO₂ in the gaseous effluent stream may also be absorbed in the aqueous liquid phase and removed from the gaseous stream.

Alternatively, the effluent stream exiting the conversion reaction zone may be cooled sufficiently to cause a fraction of the hydrocarbon products in the effluent stream to condense. The cooled effluent mixture may then be separated in a three-phase separator, from which a liquid aqueous phase, a liquid hydrocarbon phase and a dewatered gaseous phase comprising H₂O, CO, CO₂, and the remaining hydrocarbons are recovered. The liquid aqueous phase from the three-phase separator, including a fraction of the CO₂ present in the gaseous effluent, may be prepared for disposal, for recycling to the present process, or for other uses. LPG in the liquid hydrocarbon phase is separated from the remaining hydrocarbons in the liquid phase, generally by fractional distillation. The dewatered gaseous phase comprises CO, CO₂ and H₂, LPG, C2− hydrocarbons (e.g., methane and ethane) and C5+ hydrocarbons (principally pentane with decreasing amounts of higher hydrocarbons).

In embodiments, the process comprises contacting at least a portion of the dewatered gaseous effluent with a liquid absorption solvent in an absorption zone and recovering an LPG-enriched liquid and a recycle stream having a reduced LPG content. The process further comprises contacting at least a portion of the dewatered gaseous effluent with a liquid absorption solvent in an absorption zone at a relatively higher pressure and/or relatively lower temperature, recovering an LPG-enriched liquid and a recycle stream having a reduced LPG content, and desorbing the absorbed hydrocarbons from the LPG-enriched liquid at a relatively lower pressure and/or higher temperature. The desorbed hydrocarbons may be fractionated, to recover at least a light gas fraction comprising CO, CO₂, H₂, C2− hydrocarbons, and an LPG fraction; and passing the recovered light gas fraction to the reforming reaction zone. One exemplary solvent absorption process is termed “sponge oil absorption”.

In embodiments, the process comprising contacting at least a portion of the dewatered gaseous effluent with a liquid absorption solvent in an absorption zone at a pressure between about 250 psi and about 1500 psi, wherein the non-adsorbed components are returned to the recycle stream in the same pressure range. Thus, the recycle stream leaving the absorption zone requires minimal compression as it is returned to the reforming reaction zone.

In one aspect, the solvent absorption process removes much of the C3+ hydrocarbons (e.g., propane, butane, pentane) from the dewatered gaseous effluent. A smaller fraction of CO₂ may also be removed in certain cases, while little or no H₂, CO, and methane are removed. The removed CO₂ may be recycled to one or more of the reaction zones, vented, or captured for other uses and other disposal options. Cycling the solvent substrate containing dissolved hydrocarbons to a region of relatively lower pressure and/or high temperature removes the absorbed hydrocarbons as gas phase components, for further downstream separation to recover LPG at high purity. The hydrocarbon lean organic solvent substrate is then cycled back to the absorption step. Organic solvent substrates useful for solvent absorption may be selected on the basis of aromaticity. When low aromaticity is required, a nC16 paraffinic hydrocarbon may be selected. For more aromaticity, kerosine would be an optional solvent. For relatively higher aromaticity, light cycle oil would be an optional solvent. All are readily available from standard refinery operations.

In embodiments, the process comprises separating the dewatered gaseous effluent into a purge stream and a recycle stream; contacting the purge stream with a liquid absorption solvent in an absorption zone, and recovering an LPG-enriched liquid and a non-absorbed gaseous stream having a reduced LPG content; heating the LPG-enriched liquid to vaporize at least a portion of the LPG contained therein; and recovering the LPG; returning the non-absorbed gaseous stream to the recycle stream; and passing the recycle stream to the oxygenate synthesis zone.

In some embodiments, the entire dewatered gaseous phase is contacted by the solvent absorption separation step. In other embodiments, only a fraction of the dewatered gaseous phase is treated, by removing a purge stream from the dewatered gaseous phase for contacting with the liquid absorption solvent. C3+ hydrocarbons and CO₂ in this purge stream are absorbed by the circulating organic solvent, and recovered as desired product (e.g., LPG), as byproducts (e.g., C5+ hydrocarbons), or as components to return as recycle (e.g., CO₂, CO and H₂). In embodiments, the purge stream treated in the organic solvent absorber comprises between 10% and 90% of the dewatered gaseous effluent, or between 20% and 80%, or between 30% and 70%, or even between 40% and 60% of the dewatered gaseous effluent.

In one aspect, removing a purge stream of dewatered gaseous phase for separating out hydrocarbons has the effect of increasing the amount of LPG remaining in the dewatered gaseous phase while reducing the loss of CO₂ in the absorber. However, it has been surprisingly discovered that removing LPG from a purge stream portion of the gaseous phase rather than from the entire gaseous phase has several unexpected benefits. In one aspect, separating only a purge stream reduces the CO₂ loss from the overall process, making more recycle CO₂ available for controlling the reforming reaction and the oxygenate synthesis reaction, and reducing CO₂ loss to the atmosphere. Further, while removing only a portion of the LPG in the gaseous phase causes the LPG content to increase in the recycle loop, the net effect on the size of the reaction zones and on the synthesis reaction and the conversion reaction is minimal. Further, we have discovered that the recycled LPG is largely inert to both the synthesis reaction and the conversion reaction, such that the LPG is neither altered during the reactions, nor does it contribute in any substantial way to the reactions. Further, contacting only a purge stream of the dewatered effluent using an organic solvent absorber enables the use of smaller compressors and absorbers, resulting in reduced equipment and operating costs. Thus, while recycling a portion of the LPG that is generated in the conversion reaction leads to an increase in reactor sizes to accommodate the additional flow, the increase in size is found to be minimal. In effect, passing only a portion of the dewatered gaseous phase through the solvent absorption process during each cycle increases the removal efficiency of the hydrocarbons in the absorption process, while decreasing the required size of the absorption process.

The organic solvent absorption separation as outlined above may remove only a fraction of the C2− hydrocarbon byproducts, principally methane and ethane, if at all. To avoid a byproduct build-up in the gaseous effluent, a solid adsorption process (otherwise termed a “pressure swing adsorption” or PSA process) may be provided to remove a substantial amount of these C2− hydrocarbon byproducts from the recycle stream. Accordingly, the method may include the steps of adsorbing the C2− hydrocarbons, CO, and CO₂ onto the solid adsorbent at an adsorption pressure above 400 psi; separating a light fraction comprising the adsorbed C2− hydrocarbons, CO, and CO₂ from the solid absorbent at a pressure at least 25 psi below the adsorption pressure; recycling the light fraction; and returning non-adsorbed H₂ to the recycle stream at a pressure above 400 psi. The recycle stream may be used, for example, as a blending component to the biogas feed to the reforming reaction zone, as a blending component to the synthesis gas feedstock to the 1^{st} reaction zone, or as a fuel for internal or external use.

Hydrogen is a valuable component of the recycle stream, and the separation alternatives are selected to retain most, if not all, of the hydrogen within the reaction and recycle loop. Little (e.g. less than 10 mol % or less than 1 mol %) of the hydrogen in the dewatered gaseous effluent is removed from the effluent in the liquid absorption solvent. Most of the components of the recycle stream that is contacted with the adsorbent in the solid adsorption process are adsorbed by the solid adsorbent and removed from the recycle stream. The exception is H₂; greater than 80 weight % of the hydrogen in the purge stream is returned to the recycle stream. And, since only H₂ is substantially rejected by the solid adsorbent, the non-adsorbed components returned to the recycle stream comprise greater than 90 mole % H₂.

Processes for making LPG in which a PSA process is the sole separation process for recovering LPG from the reaction effluent may be preceded by a silica gel bed for removing C3+ hydrocarbons and an activated carbon bed for removing C2− hydrocarbons. Alternatively, the PSA module may be operated in conjunction with the solvent absorption process, either before or after solvent absorption. In embodiments, the process comprises contacting at least a portion of the recycle stream over a solid adsorbent for adsorbing at least a portion of unreacted biosyngas components, including CO and CO₂, and at least a portion of the C2− hydrocarbons contained therein, and returning non-adsorbed H₂ to the recycle stream. Typical adsorbents that may be used include one or more of a zeolitic molecular sieve, activated carbon, silica gel, alumina, and synthetic resins.

In one aspect, the process comprises contacting the entire recycle stream from the hydrocarbon liquid absorption process step with the solid adsorbent. In another aspect, the process comprises contacting a purge stream comprising a portion (e.g., between about 5% and about 50%, about 10% and about 40%, or about 15% and about 30%) of the recycle stream from the solvent absorption zone with the solid adsorbent and adsorbing at least a portion of the C2− hydrocarbons, CO, and CO₂ contained therein. It is noted that if the recycle stream portion is too low, excess C2− builds up in the recycle gas and lowers conversion. If the recycled stream portion is too high, too much CO and CO₂ are lost.

Most of the components of the purge stream, except for H₂, are adsorbed by the solid adsorbent and removed from the purge stream. Thus, greater than 80 weight % of the hydrogen in the purge stream may be returned to the recycle stream. Further, H₂ may comprise greater than 90 mole % of the non-adsorbed components returned to the recycle stream. Thus, the purge stream is removed from the recycle stream at a pressure between about 250 psi and about 1500 psi, and the non-adsorbed components are returned to the recycle stream in the same pressure range. At least a portion of the CO, CO₂, methane, and ethane adsorbed in the PSA separation are recovered as low-pressure gases. The low-pressure gases may be compressed and sent to the reforming reaction zone. or used as a fuel for internal or external use.

In an additional aspect, the process comprises treating a first purge stream that is separated from the dewatered gaseous effluent in the liquid absorption zone, and treating a second purge stream that is separated from the non-absorbed component of the first purge stream in a solid adsorption zone.

The process for producing a bioLPG product is configured and operated to produce LPG (propane and/or butane in varying rations) as the primary hydrocarbon product. Other hydrocarbons that may be produced include one or more of methane, ethane and C5+ hydrocarbons, primarily pentane. Separation of the hydrocarbon products into purified component products generally involves fractional distillation. The fractionation train may consist of multiple distillation towers in series, including a deethanizer, a depropanizer, a debutanizer and a butane splitter. The overhead product of the deethanizer is methane and ethane and, depending on the process conditions, one or more of CO, CO₂ and H₂. The deethanizer bottoms may be fed to the depropanizer. The overhead product from the depropanizer is propane and the bottoms are fed to the debutanizer. The overhead product from the debutanizer is a mixture of normal and iso-butane, and the bottoms product is a C5+ gasoline mixture.

Operation of and catalyst selection for the oxygenate conversion reaction zone may contribute to a simpler fractionation train. For example, use of a molecular sieve catalyst in the oxygenate conversion reaction zone may limit the relative quantity of C5+ hydrocarbons that are present in the hydrocarbon product stream. Use of a small-pore molecular sieve, such as SSZ-13, may limit the production of C5+ hydrocarbons further. Under these and similar conditions, the hydrocarbon fractionation train may be limited to a single deethanizer fractionation column, with the gaseous overhead passed as recycle to the reforming reaction zone, and the deethanizer bottoms product recovered as LPG for use as a fuel, e.g., Autogas, a widely recognized transportation “green fuel” for reduced CO₂ exhaust emissions.

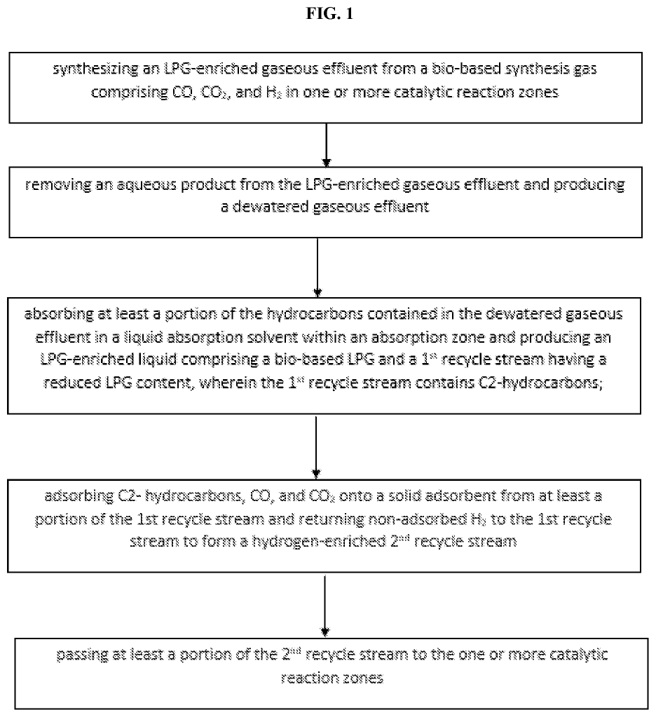

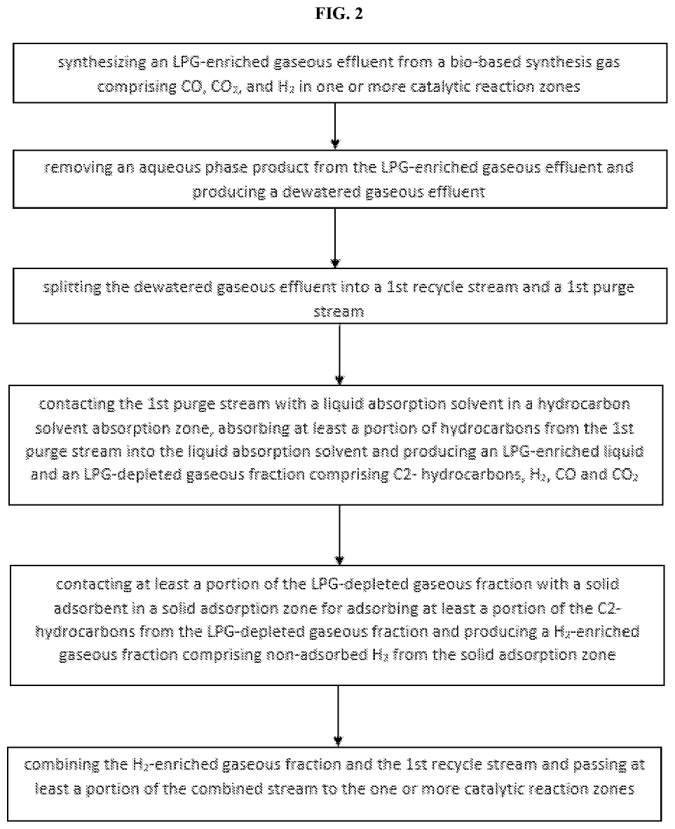

An exemplary embodiment of the process for utilizing recycle in the production of an LPG product may be understood by the following description, and in reference to the accompanying FIGS. 1-4. The FIGs. present illustrations of a process involving certain operational principles. To facilitate explanation and understanding, the FIGs. provide a simplified overview, and depicted elements are not necessarily drawn to scale. Valves, instrumentation, and other equipment and systems not essential to the understanding of the various aspects of the invention are not shown. As is readily apparent to one of skill in the art having knowledge of the present disclosure, processes for producing LPG via the reactions as disclosed herein, may have alternative configurations and elements that are governed by the specific operating objectives, but which alternatives are nonetheless within the scope of the invention.

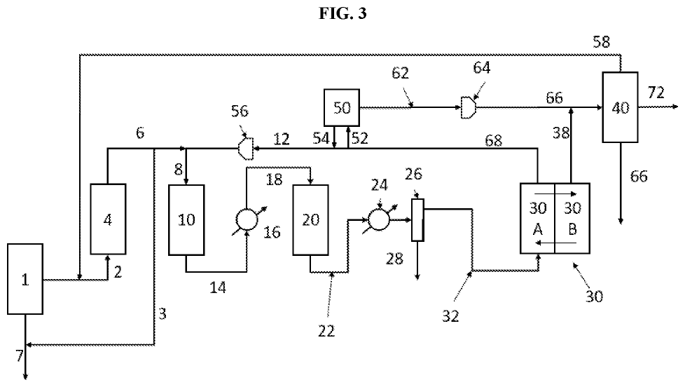

FIG. 3 presents an embodiment of the present disclosure providing flow scheme of the process for utilizing recycle in the production of LPG product.

Biogas 1 may be produced from bio-based sources, including, for example, anaerobic bacterial digestion, composting, biomass gasification, pyrolysis or hydropyrolysis, landfill gases, or gaseous products of the electrochemical reduction of carbon dioxide. Bio-based biogas 1 may be combined with at least a portion of recycle 58, comprising unreacted H₂, CO, CO₂, and C2− hydrocarbons from separation zone 40, and the mixture 2 passed to reforming reaction zone 4 for conversion to biosyngas 6.

Contaminants in the biogas, including sulfur compounds and/or CO₂ in excess of that needed in downstream processing, may be removed from the biogas through stream 7. Biogas sulfur may be removed to low levels, and often to ppm levels, using, for example, one or more of aqueous washing, alkanolamine absorption, molecular sieve adsorption, selective catalytic oxidation, and hydrodesulfurization. Excess CO₂ may be removed from the biogas in combination with sulfur removal. Additional CO₂ may be removed by membrane separation, by cryogenic distillation or by aqueous absorption, which includes contacting the biogas with water to dissolve CO₂, separating the water/CO₂ mixture, removing the CO₂ from the mixture by increasing the temperature and/or decreasing the pressure of the mixture, and recycling the water. CO₂ may also be removed in part by aqueous absorption into the water that is condensed and removed from the biogas. In some aspects, CO₂ may also be removed through stream 3 from the product syngas 6 for CO₂/CO ratio control.

The methane-containing biogas 2 is converted to biosyngas 6 comprising CO, CO₂, H₂O, and H₂ in a reforming reaction zone 4 at pressures between about 200 psi and about 600 psi (14-40 bar) with outlet temperatures in the range of 815 to 925° C. The reforming reaction may take place over a shaped nickel alumina catalyst.

The ratio of H₂/(CO+CO₂) in the biosyngas product 6 exiting the reformer is tailored to meet the requirements of downstream processing. Accordingly, the composition of the biogas feed to the reformer, including the amount of CO₂ and H₂O included in the biogas feed, may be modified to exploit reforming and/or water gas shift reactions to achieve the desired H₂/(CO+CO₂) composition of the biosyngas product 6.

Blended bio-based synthesis gas 8 comprising fresh biosyngas 6 and hydrogen-enriched recycle gas 12 and having a H₂/(CO+CO₂) molar ratio of between 2 and 3 is passed to synthesis reaction zone 10, for synthesizing a gaseous oxygenate comprising methanol by reacting the bio-based synthesis gas 8 over a non-zeolitic methanol synthesis catalyst in the synthesis reaction zone 10 containing a oxygenate synthesis catalyst to form a synthesis reaction zone effluent 14 that is enriched in MeOH.

The synthesis reaction zone 10 may be operated at a temperature between about 220° C. and about 350° C. and at a pressure between about 250 psi and about 1500 psi. The effluent product from the synthesis reaction zone 10, leaving the reaction at the reaction zone temperature, may be heated to a temperature between about 280° C. and about 500° C., or between about 300° C. and about 475° C. in a heating zone 16, and the heated synthesis effluent 18 passed to the hydrocarbon conversion zone 20, in which the oxygenates in the effluent are converted to hydrocarbons, including LPG.

LPG-enriched gaseous effluent 22 comprises LPG, byproduct C2− and C5+ hydrocarbons, water, and unreacted gases H₂, CO, and CO₂. Product recovery and unreacted gas recycle takes place in a sequence of liquid and gaseous processing and separations. The conversion reaction zone effluent 22, exiting conversion reaction zone 20 as a heated vapor, is cooled to condense at least a portion of the water vapor contained in the effluent.

The chiller 24 through which the LPG-enriched gaseous effluent 22 passes is operated at conditions such that at least a portion of the water vapor contained in effluent 22 is condensed as aqueous phase 28 and removed from the gas phase components, for disposal, for recycling to the present process, or for other uses. In an aspect, a portion of the CO₂ in the LPG-enriched gaseous effluent 22 is absorbed into the aqueous phase 28 prior to separation.

At least a portion of the dewatered gaseous effluent is passed to a solvent absorption zone 30, for absorbing at least a portion of the hydrocarbons contained in the dewatered gaseous effluent 32 in a liquid absorption solvent within the absorption zone 30 and producing an LPG-enriched product 38 comprising a bio-based LPG and a 1^{st} recycle stream 68 having a reduced LPG content.

Solvent absorption zone includes a contacting zone 30A, maintained at a relatively lower absorbent temperature and/or a relatively higher absorbent pressure, and a regeneration zone 30B, maintained at a relatively higher regeneration temperature and/or a relatively lower regeneration pressure. Dewatered gaseous effluent 32 entering the absorption zone contacts a lean absorbent in the contacting zone 30A.

The liquid absorbent is a liquid phase material that remains a liquid at the operating temperature of the solvent absorbent unit. In one aspect, the liquid absorbent is a hydrocarbon liquid in which the C3+ hydrocarbons in the gaseous effluent are readily soluble. The liquid absorbent may have a normal boiling point greater than 100° C. In one aspect, the liquid absorbent is selected from the group consisting of an nC16 paraffinic hydrocarbon, kerosine, and light cycle oil.

Recovery of LPG from the solvent absorption separation zone 30 involves separating absorbed hydrocarbons from the liquid absorption solvent in the solvent absorption separation zone, recovering at least a 1^{st} light fraction 58 comprising C2− hydrocarbons and an LPG fraction 72 comprising the bio-based LPG from the separated hydrocarbons.

Separation zone 40 represents one or more fractionation steps, generally in separate fractionators, for recovery of purified LPG 72 and isolation of C2− hydrocarbons 58. CO and CO₂ that are removed from the dewatered gaseous effluent are isolated in overhead stream 58. When the hydrocarbon product stream 66 contains significant amounts of C5+ hydrocarbons 70, they may be separated from the LPG product in a debutanizer distillation column (not shown). In some cases, the overhead C2− hydrocarbon fraction 58 also contains unreacted syngas components, principally CO and CO₂ and some H₂. The overhead C2− hydrocarbon fraction containing unreacted syngas components may be recycled 58 to the reforming reaction zone for additional reforming reactions.

Unreacted gases remaining in recycle stream 68 following solvent absorption comprises the unreacted gases CO, CO₂, and H₂, and unabsorbed C2− vapor phase hydrocarbons. A purge stream 52 separates a portion of the recycle stream, to control, in part, the amount of light hydrocarbon gases, e.g., methane and ethane, in the recycle stream 68, and optionally to control the amount of hydrogen being recycled to the synthesis reaction zone 10.

In embodiments, a solid phase adsorbent separation zone 50 is provided for adsorbing C2− hydrocarbons, CO, and CO₂ from at least a portion of the 1^{st} recycle stream 52 onto a solid adsorbent and returning non-adsorbed H₂ 54 to the 1^{st} recycle stream 68 to form a hydrogen-enriched 2^{nd} recycle stream 12. In further embodiments, the separation zone provided for separating purge stream components includes a solid adsorbent that is selected to remove one or more components from the purge stream 52. The remaining gas phase 54 after removal of adsorbed components is returned to the recycle stream 68 for recycling to the synthesis reaction zone 10.

A pressure swing adsorption (PSA) module is suited for removing hydrocarbons, CO, and CO₂ from the purge stream by adsorption onto a selective adsorbent material (e.g., zeolites or activated carbon) while rejecting hydrogen. Use of a PSA module involves adsorbing the C2− hydrocarbons, CO, and CO₂ from at least a portion of the 1^{st} recycle stream 68 onto the solid adsorbent at an adsorption pressure above 400 psi, separating a 2^{nd} light fraction 62 comprising the adsorbed C2− hydrocarbons, CO, and CO₂ from the solid absorbent at a pressure at least 25 psi below the adsorption pressure. After a pressure increase through purge gas compressor 64, the 2^{nd} light fraction is recycled from separation zone 40 through stream 58. Non-adsorbed H₂ 54 is returned to the 1^{st} recycle stream 68 at a pressure above 400 psi.

Recycling unreacted synthesis gas components involves a minimum pressure drop, involving only a small amount of recompression through compressor 56. Accordingly, the method includes increasing the pressure of the at least a portion of the hydrogen-enriched recycle stream 12 in the range between 5 psi and 50 psi and blending the pressurized hydrogen-enriched recycle stream with the bio-based synthesis gas.

During operation of separation zone 40, at least one of the PSA offgases 62 and the hydrocarbon-rich gaseous phase 38 are passed to the separation zone 40 for recovery of LPG and recycle of the remaining components. C2− hydrocarbons, CO, and CO₂ are recovered as stream 58 and recycled to the reforming reaction zone 4. The LPG produced in this way contains only a trace of C5+ hydrocarbons, qualifying this LPG as a European AutoGas fuel.

The separation zone 40, shown in FIG. 3 as a single vessel, may include two or more fractionators, each separating different components of feedstream 66, distinguished by boiling point range. In embodiments, one of the fractionators may be described by the term of art as a “deethanizer”, or as a “depropanizer”, or as a “debutanizer.”

The selection of units for recovering LPG from the process, and for recycling much of the unreacted reactants while minimizing loss of CO₂ from the system, is based in part on the objective of operating the recycle system with a minimum of recompression of recycle components. Thus, hydrocarbon products in the dewatered gaseous effluent 32 are absorbed into the solvent and removed from the recycle stream, while the unreacted gaseous components (H₂, CO and CO₂) are rejected by the absorption solvent and returned to the recycle stream 68 with minimum pressure drop.

Likewise, components of the recycle that are removed by the PSA are removed at high pressure and recovered at low pressure. Hydrogen 54 that is rejected by the PSA is returned to the recycle stream at high pressure, requiring a minimum of compression to account for pressure losses through the recycle system.

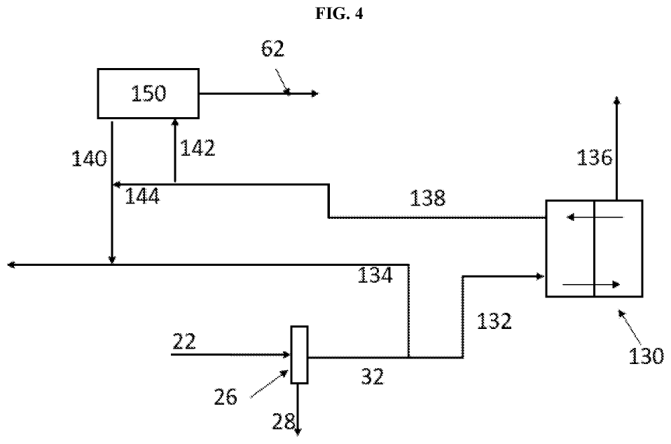

FIG. 4 illustrates an embodiment, including separating a purge stream from the dewatered gaseous effluent for treating in the hydrocarbon solvent absorption process.

LPG-enriched gaseous effluent 22 is passed to knockout pot 26 for separating liquid water 28 from the dewatered gaseous effluent 32.

The dewatered gaseous effluent 32 comprises the LPG product, C2− and C5+ hydrocarbon byproducts, water vapor and unconverted syngas components, H₂, CO, and CO₂. According to the embodiment illustrated in FIG. 4, the dewatered gaseous effluent 32 is split into a 1^{st} purge stream 132 and a recycle stream 134. In embodiments, the 1^{st} purge stream 132 constitutes between about 10% and about 90% of the dewatered gaseous effluent 32.

The 1^{st} purge stream is contacted with a liquid absorption solvent in hydrocarbon solvent absorption zone 130. The liquid absorption solvent is suitable for absorbing at least a portion of hydrocarbons from the 1^{st} purge stream into the liquid absorption solvent at an absorption temperature and at an absorption pressure and producing an LPG-enriched liquid and an LPG-depleted gaseous fraction 138 comprising C2− hydrocarbons, H₂, CO and CO₂. An LPG-enriched gaseous fraction 136 is recovered from the LPG-enriched liquid at a temperature that is higher than the absorption temperature and/or at a pressure that is lower than the absorption pressure. The LPG-enriched gaseous fraction may be further fractionated to recover bio-based LPG.

A solid adsorption zone, such as a PSA separator, is provided to remove at least a portion of the C2− hydrocarbons present in the LPG-depleted gaseous fraction 138. The C2− hydrocarbons are valuable as reforming reaction zone feedstock or as fuel for internal and/or external use. Removing the C2− hydrocarbons at this point decreases the amount of C2− hydrocarbons passed to the catalytic reaction zones. In one aspect, the entire LPG-depleted gaseous stream 138 is passed to the solid absorption zone.

In another aspect, the process comprises splitting the LPG-depleted gaseous stream 138 into a 2^{nd} purge stream 142 and a 2^{nd} recycle stream 144; contacting the 2^{nd} purge stream 142 with the solid adsorbent in the solid adsorption zone 150 for adsorbing at least a portion of the C2− hydrocarbons from the 2^{nd} purge stream producing a H₂-enriched gaseous fraction 140 comprising the non-adsorbed H₂ from the solid adsorption zone; combining the H₂-enriched gaseous fraction 140, the 2^{nd} recycle stream 144 and the 1^{st} recycle stream 134 and passing at least a portion of the combined stream to the one or more catalytic reaction zones. In another aspect, the 2^{nd} purge stream 142 constitutes between about 5% and about 50% (or about 10% and about 40%, or about 15% and about 30%) of the LPG-depleted gaseous fraction.

Most of the components of the purge stream are adsorbed by the solid adsorbent and removed from the purge stream. The exception is H₂, that is not substantially removed. Thus, greater than 80 weight % of the hydrogen in the purge stream is returned to the recycle stream. And, since only H₂ is substantially rejected by the solid adsorbent, the non-adsorbed components returned to the recycle stream comprise greater than 90 mole % H₂. Likewise, the purge stream is removed from the recycle stream at a pressure between 250 psi and 1500 psi, and the non-adsorbed components are returned to the recycle stream in the same pressure range.

As noted above, the PSA offgases 62 that are removed from the 2^{nd} purge stream 142 and C2− hydrocarbon fraction (reference number 58 in FIG. 3) that is separated from the LPG-enriched gaseous fraction 136 contain C2− hydrocarbons as well as H₂, CO, and CO₂. Thus, the PSA offgas 62 and the C2− hydrocarbon fraction 58, as individual streams or as a blend of the two streams, may be used as a blending component to the synthesis gas feedstock to the 1st reaction zone, or as a fuel for internal or external use.

### EXAMPLES

The following non-limiting examples illustrate the content and technical solutions of the disclosure, but do not limit the scope of the invention.

The present process was modeled using AspenTech software to evaluate the losses of the synthesis gas components H₂, CO, and CO₂ from the process for various recycle recovery options. In each case, reaction conditions and process flows other than the composition of the recycle stream were kept constant.

Four process were considered to evaluate:
Run #1: The entire dewatered gaseous effluent is contacted in a liquid absorption solvent zone to remove hydrocarbons. A resulting recycle stream is then contacted with a solid adsorbent to remove CO, CO₂, and remaining hydrocarbons.
Run #2: The entire dewatered gaseous effluent is contacted in a liquid absorption solvent zone to remove hydrocarbons. A 10% portion of the resulting recycle stream is then removed as a purge from the recycle stream.
Run #3: The entire dewatered gaseous effluent is contacted in a liquid absorption solvent zone to remove hydrocarbons. A 10% portion of the resulting recycle stream as purge is then contacted with a solid adsorbent to remove CO, CO₂ and remaining hydrocarbons.
Run #4: A 40% portion of the dewatered gaseous effluent is contacted in a liquid absorption solvent zone to remove hydrocarbons. A 25% portion of the resulting recycle stream is then contacted with a solid adsorbent to remove CO, CO₂, and remaining hydrocarbons.

The data in Table 1 tabulates the % losses of each synthesis gas component that is lost from the process, based on the % of gaseous effluent flow to the water knockout pot.

TABLE 1
Gas Losses, % of flow to water knockout

| | Run #1 | Run #2 | Run #3 | Run #4 |
|---|---|---|---|---|
| H₂ | 12% | 10% | 1% | 1% |
| CO | 100% | 12% | 12% | 11% |
| CO₂ | 100% | 31% | 31% | 17% |

As shown in Table 1, contacting 100% of the gaseous effluent with both the sponge oil absorption and the Pressure Swing Adsorption (PSA) results in total loss of CO and CO₂. Contacting 100% of the gaseous effluent with the sponge oil absorption and then removing 10% of the gaseous recycle reduces the loss of H₂ to 10%, of CO to 12% and CO₂ to 31%. Loss of H₂ is reduced to 1% with a 10% purge of the recycle stream being directed to PSA. The lowest amount of H₂, CO, and CO₂ loss occurs when the sponge oil absorption treatment is applied to a 40% purge stream of the gaseous effluent, followed by a PSA treatment of 25% of the resulting recycle stream. This data clearly illustrates the benefit of using the sponge oil treatment and the PSA treatment of the gaseous recycle for recovering synthesis gas components from the recycle gas. The data also illustrates the additional benefit of treating only a fraction of the gaseous recycle using the two treatment steps.

### REFERENCE NUMBERS

Ref No. Description
1 Bio-based biogas
2 Mixture/methane-containing biogas
3 Recovered CO₂
4 reforming reaction zone
6 Syngas/biosyngas product/fresh biosyngas
7 Stream/biogas generation
8 Blended bio-based synthesis gas/bio-based synthesis gas
10 synthesis reaction zone
12 hydrogen-enriched recycle gas
14 synthesis reaction zone effluent
16 heating zone
18 synthesis effluent
20 hydrocarbon conversion zone
22 LPG-enriched gaseous effluent
22 gaseous effluent
24 chiller
26 knockout pot
28 liquid water/aqueous phase
30 solvent absorption zone
30A contacting zone
30B regeneration zone
32 dewatered gaseous effluent
38 LPG-enriched product
40 separation zone
50 solid phase adsorbent separation zone
52 1^{st} recycle stream
54 non-adsorbed H₂
56 compressor
58 C2− hydrocarbon fraction/recycle/1^{st} light fraction
62 PSA offgases/2^{nd} light fraction
64 purge gas compressor
66 hydrocarbon product stream/feedstream
68 recycle stream/1^{st} recycle stream
70 C5+ hydrocarbons
72 LPG fraction
130 hydrocarbon solvent absorption zone
132 1^{st} purge stream
134 recycle stream
136 LPG-enriched gaseous fraction
138 LPG-depleted gaseous fraction
140 H₂-enriched gaseous fraction
142 2^{nd} purge stream
144 2^{nd} recycle stream
150 solid adsorption zone

1. A method for producing bio-based LPG, comprising:
a) synthesizing an LPG-enriched gaseous effluent from a bio-based synthesis gas comprising CO, CO₂, and H₂ in one or more catalytic reaction zones;
b) removing an aqueous product from the LPG-enriched gaseous effluent and producing a dewatered gaseous effluent;
c) absorbing at least a portion of the hydrocarbons contained in the dewatered gaseous effluent in a liquid absorption solvent within an absorption zone and producing an LPG-enriched product comprising a bio-based LPG and a 1^{st} recycle stream having a reduced LPG content, wherein the 1^{st} recycle stream contains C2− hydrocarbons;
d) adsorbing C2− hydrocarbons, CO, and CO₂ from at least a portion of the 1^{st} recycle stream onto a solid adsorbent and returning non-adsorbed H₂ to the 1^{st} recycle stream to form a hydrogen-enriched recycle stream; and
e) passing at least a portion of the hydrogen-enriched recycle stream to the one or more catalytic reaction zones.

2. The method of claim 1, further comprising recovering bio-based LPG by fractional distillation of the LPG-enriched product.

3. The method of claim 1, wherein the bio-based synthesis gas comprising CO, CO₂, and H₂ in step (a) is prepared by contacting a biogas comprising biomethane with an oxidizing gas selected from O₂, CO₂ and H₂O or combinations thereof at reforming reaction conditions in a reforming reaction zone.

4. The method of claim 1, wherein after step c) absorbed hydrocarbons from the liquid absorption solvent is separated; and at least a 1^{st} light fraction comprising C2− hydrocarbons and an LPG fraction comprising the bio-based LPG from the separated hydrocarbons is recovered.

5. The method of claim 1, wherein step c) is conducted by absorbing at least a portion of hydrocarbons in the dewatered gaseous effluent into a liquid absorption solvent in an absorption zone at a temperature of less than 50° C. and at a pressure between about 250 psi and about 1500 psi.

6. The method of claim 1, wherein the liquid absorption solvent is selected from nC16 paraffinic hydrocarbon, kerosine, and light cycle oil.

7. The method of claim 1, wherein step c) is conducted by contacting a 1^{st} purge stream comprising between about 10% and about 90% of the dewatered gaseous effluent with the liquid absorption solvent, absorbing at least a portion of hydrocarbons in the 1^{st} purge stream into the liquid absorption solvent and producing the LPG-enriched product and the 1^{st} recycle stream.

8. The method of claim 1, wherein step d) is conducted by:
f) adsorbing the C2− hydrocarbons, CO, and CO₂ from at least a portion of the 1^{st} recycle stream onto the solid adsorbent at an adsorption pressure above 400 psi;
g) separating a 2^{nd} light fraction comprising the adsorbed C2− hydrocarbons, CO, and CO₂ from the solid absorbent at a pressure at least 25 psi below the adsorption pressure;
h) recycling the 2^{nd} light fraction; and
i) returning non-adsorbed H₂ to the 1^{st} recycle stream at a pressure above 400 psi.

9. The method of claim 1, wherein a 2^{nd} purge stream comprising between about 5% and about 50%, about 10% and about 40%, or about 15% and about 30% of the 1^{st} recycle stream and adsorbing C2− hydrocarbons, CO, and CO₂ onto the solid adsorbent from the 2^{nd} purge stream.

10. The method of claim 1, wherein step (e) of passing at least a portion of the hydrogen-enriched recycle stream to the one or more catalytic reaction zones comprises increasing the pressure of the at least a portion of the hydrogen-enriched recycle stream in the range between 5 psi and 50 psi and blending the pressurized hydrogen-enriched recycle stream with the bio-based synthesis gas.

11. The method of claim 1, further comprising:
j) synthesizing a gaseous oxygenate comprising methanol by reacting the bio-based synthesis gas over a non-zeolitic methanol synthesis catalyst in a synthesis reaction zone; and
k) synthesizing the LPG-enriched gaseous effluent by reacting at least a portion of the gaseous oxygenate over a zeolitic oxygenate conversion catalyst in a conversion reaction zone.

12. The method of claim 11, wherein at least 50% of the gaseous oxygenate is MeOH.

13. The method of claim 11, wherein, in step j), the bio-based synthesis gas in the synthesis reaction zone is reacted at a reaction temperature between about 220° C. and about 350° C. and a pressure of between about 700 psi and about 1500 psi; and in step k), at least a portion of the gaseous oxygenate in the conversion reaction zone is reacted at a reaction temperature between about 280° C. and about 500° C. and a pressure between about 700 psi and about 1500 psi.

14. The method of claim 13, wherein the reaction temperature in the conversion reaction zone is at least 25° C. higher than the reaction temperature in the synthesis reaction zone.

15. The method of claim 11, wherein at least a portion of the gaseous oxygenate in the conversion reaction zone is reacted at a pressure above about 750 psi, and producing the LPG-enriched gaseous effluent comprising less than 2 mol % olefins.

16. The method of claim 11, wherein the non-zeolitic oxygenate synthesis catalyst in the synthesis reaction zone comprises one or more oxygenate synthesis-active metals selected from Cu, Zn, Zr, Al, Pt, Pd, Rh, Ru, and Cr.

17. The method of claim 11, wherein the zeolitic oxygenate conversion catalyst is a zeolite having a SiO₂/Al₂O₃ molar ratio of less than 90.

18. The method of claim 11, wherein the zeolitic oxygenate conversion catalyst is a molecular sieve-containing oxygenate conversion catalyst comprising less than 1 wt % of Cu, Zn, Zr, Al, Pt, Pd, Rh, Ru, and Cr, either alone or in combination.

19. The method of claim 11, wherein, in step j), the bio-based synthesis gas is reacted at an inlet temperature between about 220° C. and about 300° C. and recovering the gaseous oxygenate at an outlet temperature between about 280° C. and about 500° C.; and in step k), the gaseous effluent is reacted at a temperature between about 280° C. and about 500° C.

20. A method for producing bio-based LPG, comprising:
i. synthesizing an LPG-enriched gaseous effluent from a bio-based synthesis gas comprising CO, CO₂, and H₂ in one or more catalytic reaction zones;
ii. removing an aqueous phase product from the LPG-enriched gaseous effluent and producing a dewatered gaseous effluent;
iii. splitting the dewatered gaseous effluent into a 1^{st} recycle stream and a 1^{st} purge stream;
iv. contacting the 1^{st} purge stream with a liquid absorption solvent in a hydrocarbon solvent absorption zone, absorbing at least a portion of hydrocarbons from the 1^{st} purge stream into the liquid absorption solvent and producing an LPG-enriched product and an LPG-depleted gaseous fraction comprising C2− hydrocarbons, H₂, CO and CO₂;
V. contacting at least a portion of the LPG-depleted gaseous fraction with a solid adsorbent in a solid adsorption zone for adsorbing at least a portion of the C2− hydrocarbons from the LPG-depleted gaseous fraction and producing a H₂-enriched gaseous fraction comprising non-adsorbed H₂ from the solid adsorption zone, and;
vi. combining the H₂-enriched gaseous fraction and the 1^{st} recycle stream and passing at least a portion of the combined stream to the one or more catalytic reaction zones.

21. The method of claim 20, wherein the 1^{st} purge stream from step iii) comprises between about 10% and about 90% of the dewatered gaseous effluent.

22. The method of claim 20, further comprising recovering an LPG-enriched gaseous fraction from the LPG-enriched product after step iv).

23. The method of claim 20, further comprising,
vii. splitting the LPG-depleted gaseous stream into a 2^{nd} purge stream and a 2^{nd} recycle stream after step iv);
viii. contacting the 2^{nd} purge stream with the solid adsorbent in the solid adsorption zone for adsorbing at least a portion of the C2− hydrocarbons from the 2^{nd} purge stream producing a H₂-enriched gaseous fraction comprising the non-adsorbed H₂ from the solid adsorption zone; and
ix. combining the H₂-enriched gaseous fraction, the 2^{nd} recycle stream and the 1^{st} recycle stream and passing at least a portion of the combined stream to the one or more catalytic reaction zones.

24. The method of claim 23, wherein the 2^{nd} purge stream constitutes between about 5% and about 50%, about 10% and about 40%, or about 15% and about 30% of the LPG-depleted gaseous fraction.

25. The method of claim 20, further comprising recovering bio-based LPG by fractional distillation of the LPG-enriched product.

26. The method of claim 20, wherein absorbed hydrocarbons are separated from the liquid absorption solvent; recovering at least a 1^{st} light fraction comprising C2− hydrocarbons and the bio-based LPG after step iv).

27. The method of claim 20, wherein the liquid absorption solvent is selected from nC16 paraffinic hydrocarbon, kerosine, and light cycle oil.

28. The method of claim 20, further comprising recovering a light fraction comprising adsorbed C2− hydrocarbons, CO, and CO₂ from the solid absorbent after step v).

29. The method of claim 20, wherein step v) is conducted by:
x. adsorbing the C2− hydrocarbons, CO, and CO₂ onto the solid adsorbent at an adsorption pressure above 675 psi;
xi. desorbing the C2− hydrocarbons, CO, and CO₂ from the solid adsorbent at a pressure at least 25 psi below the adsorption pressure; and
xii. returning non-adsorbed H₂ to the 2^{nd} recycle stream at a pressure above 675 psi.

30. The method of claim 20, further comprising:
xiii. synthesizing a gaseous oxygenate comprising methanol by reacting the bio-based synthesis gas over a non-zeolitic methanol synthesis catalyst in a synthesis reaction zone; and
xiv. synthesizing the LPG-enriched gaseous effluent by reacting at least a portion of the gaseous oxygenate over a zeolitic oxygenate conversion catalyst in a conversion reaction zone.
